(19) United States
(12) Patent Application Publication
(10) Pub. No.: US 2025/0317204 A1
(43) Pub. Date: Oct. 9, 2025

(54) FREE SPACE OPTICAL COMMUNICATIONS SYSTEM AND METHOD

(71) Applicant: Oxford University Innovation Limited, Oxford (GB)

(72) Inventors: Xiuze WANG, Oxford (Oxfordshire) (GB); Guanxiong ZHANG, Oxford (Oxfordshire) (GB); Steve MORRIS, Oxford (Oxfordshire) (GB); Steve ELSTON, Oxford (Oxfordshire) (GB); Dominic Christopher O’BRIEN, Oxford (Oxfordshire) (GB); Grahame FAULKNER, Oxford (Oxfordshire) (GB); Andy SHREIER, Oxford (Oxfordshire) (GB)

(21) Appl. No.: 18/867,817

(22) PCT Filed: May 31, 2023
(86) PCT No.: PCT/GB2023/051430

§ 371 Date: Nov. 21, 2024

(30) Foreign Application Priority Data
May 31, 2022 (GB) 2208077.4

(51) Int. Cl. H04B 10/112; G02F 1/29

(52) U.S. Cl. CPC H04B 10/1123; G02F 1/29

(57) ABSTRACT

Free space optical communications systems and methods are disclosed. In one arrangement, light is generated for transmission from a first module to a second module. A first polarisation adjuster is controlled to change a polarisation of the generated light and a first polarisation dependent redirector selectively redirects light received from the first polarisation adjuster along one or more of a plurality of available directions as a function of the polarisation of the light. Light received from the first module is redirected at the second module towards a second-module detector.

The present disclosure relates to free space optical communications.

In free-space optical communications a beam of light from a transmitter is modulated to carry data. The modulated beam of light passes through free space and is detected by an optical receiver. For the highest data rates, a narrow beam of light is preferred as a high proportion of the transmitted power can be received. This leads to the problem of how to direct the light from the transmitter to the receiver, and also to point the receiver at the transmitter. There are a number of ways to do this, using steering mirrors or programmable gratings for instance. These methods offer high precision beamsteering but with very high complexity and cost.

It is an object of the invention to provide alternative and/or improved free-space communications.

According to an aspect of the invention, there is provided a free space optical communications system, comprising: a first module and a second module, the first module being configured to transmit modulated light to the second module, wherein: the first module comprises a first-module transmitter and a first-module steerer; the first-module transmitter is configured to transmit light out of the first module via the first-module steerer; the first-module steerer is configured to redirect light received from the first-module transmitter towards the second module based on a first control signal, the first-module steerer comprising: a first polarisation adjuster configured to change a polarisation of the received light based on the first control signal; and a first polarisation dependent redirector configured to selectively redirect light received from the first polarisation adjuster along one or more of a plurality of available directions as a function of the polarisation of the light; the second module comprises a second-module steerer and a second-module detector; the second-module steerer is configured to redirect light received from the first module towards the second-module detector based on a second control signal, the second-module steerer comprising: a second polarisation adjuster configured to change a polarisation of the received light based on the second control signal; and a second polarisation dependent redirector configured to selectively redirect light received from the second polarisation adjuster along one or more of a plurality of available directions as a function of the polarisation of the light; and the second-module detector is configured to detect light from the first module.

Thus, a system is provided that supports high bandwidth and high signal-to-noise while using components that are relatively inexpensive and with no moving parts. Performing the selective redirection of light (which may be referred to as beam steering) at both the transmitting first module and the receiving second module maximizes performance by directing light preferentially towards where the second module is located (by the redirection of the light at the transmitting first module) while maximising the proportion of that light that can be used at the second module (by the redirection of the light at the second module towards the detector). The latter effect may be achieved for example because the redirection allows the field of view of the second-module detector to be decreased without losing any (or an excessive proportion of) the incoming light. Reducing the field of view allows the input surface (e.g., lens) to be made larger while satisfying the requirement of conservation of étendue, thus allowing more light to be captured. The use of a combination of a polarisation adjuster and a polarisation dependent redirector has been found to be particularly efficient, while requiring no moving parts or expensive components.

In an embodiment, either or each of the first module and the second module comprises a light spreader, preferably a diffuser, configured to spread light from a radiation source such that any image of the radiation source formed outside of the first module and the second module is larger than the image would be without the light spreader. This enhances safety of the system by reducing the risk of eye damage due to inadvertent interception of concentrated radiation between the first and second modules. This effectively increases the power that can be safely emitted from each module in ranges of wavelength that may be potentially harmful. Although diffusers might be expected to disrupt coherence of light it has been found that this disruption can be limited enough to allow the redirection of light at the first and second modules (which may be implemented using diffraction) to continue to operate effectively. The spreading of light may also allow larger individual target areas to be addressed without compromising beam steering.

In an embodiment, the first module further comprises a first-module detector configured to detect light from the second module to allow bidirectional communication between the first and second modules. The first-module steerer may redirect light received from the second module towards the first-module detector along equal and opposite directions as compared to the redirection by the first-module steerer of light received from the first-module transmitter towards the second module. The first-module steerer may be large enough to allow the first-module detector and the first-module transmitter to be positioned adjacent to each other. These arrangements allow bidirectional communication to be performed in a simple and robust manner. Furthermore, the arrangements allow transmitted and received light to be processed in spatially adjacent channels, rather than relying on beam-splitting arrangements. This reduces the risk of cross-talk and thereby facilitates use of high power beams.

In an embodiment, the first-module steerer is configured to perform the redirection of light received from the second module towards the first-module detector by passing the light through a further polarisation adjuster and the first polarisation dependent redirector. The first-module steerer may thus perform the redirection of light received from the first-module transmitter and the redirection of light received from the second module by passing the light through a common first polarisation dependent redirector in opposite directions. This approach allows high power signals to be transmitted between the modules with minimal risk of cross-talk and minimal constructional complexity, including no moving parts.

In an embodiment, either or each of the first-module steerer and the second-module steerer comprises: a plurality of steering units arranged to guide propagation of light through the steering units in series, wherein each of the steering units is capable of redirecting light selectively along any of a plurality of predetermined directions relative to the steering unit. This approach provides improved flexibility for directing light to regions of interest and can be implemented at low cost and with no moving parts.

According an additional aspect of the invention, there is provided a method of performing free space optical communication between a first module and a second module, the method comprising: generating light for transmission from the first module to the second module; controlling a first polarisation adjuster to change a polarisation of the generated light and using a first polarisation dependent redirector to selectively redirect light received from the first polarisation adjuster along one or more of a plurality of available directions as a function of the polarisation of the light; and redirecting light received from the first module at the second module towards a second-module detector.

Embodiments of the disclosure will be further described by way of example only with reference to the accompanying drawings.

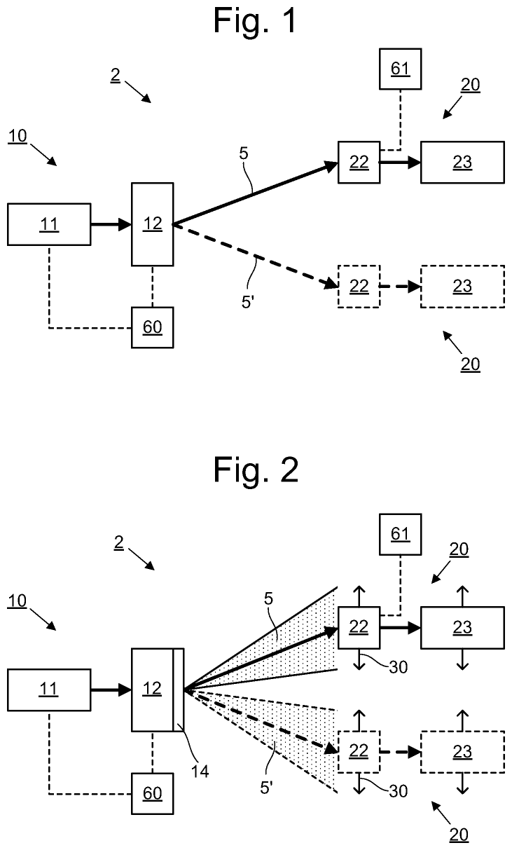

FIG. 1 is a schematic side view of a free space optical communications system comprising first and second modules and showing two example positions of the second module;

FIG. 2 shows the arrangement of FIG. 1 with the addition of a light spreader;

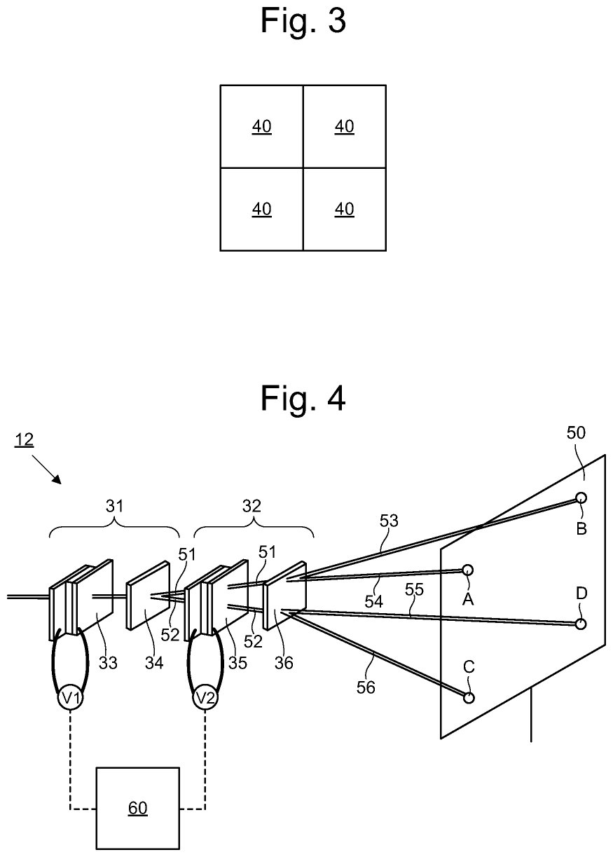

FIG. 3 depicts an example two-dimensional array of target areas;

FIG. 4 is a schematic perspective view of a free space optical communications system showing how the first-module steerer can be configured to selectively direct a beam along paths suitable for addressing a two-dimensional array of target areas of the type depicted in FIG. 3;

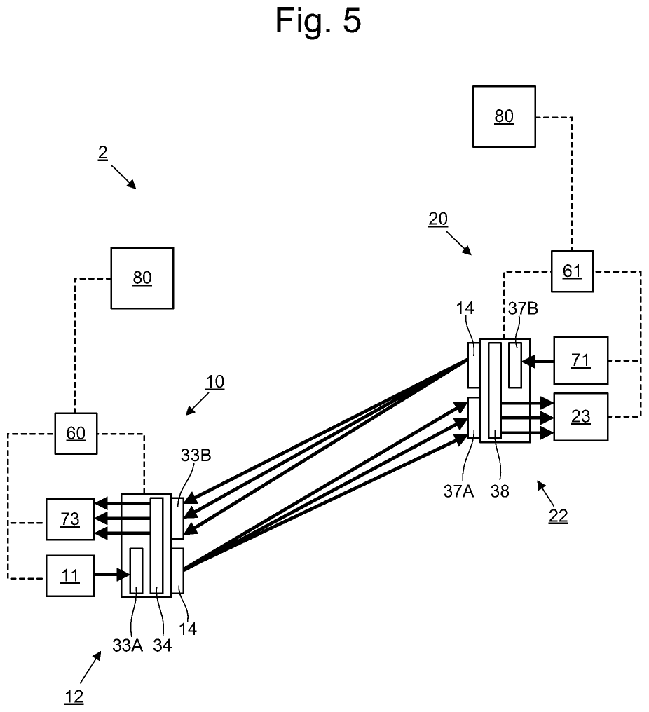

FIG. 5 is a schematic side view of a free space optical communications system comprising first and second modules and configured to provide two-way communication; and

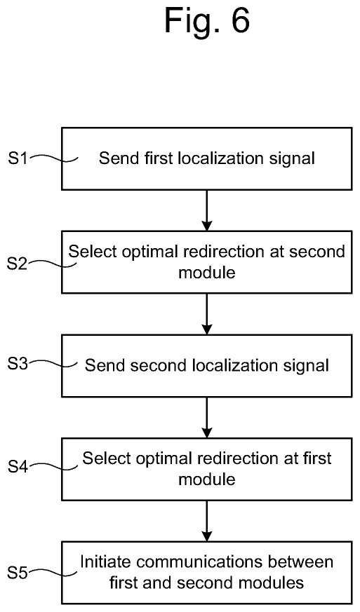

FIG. 6 is a flow chart schematically depicting a framework for a preferred localization procedure performed by first and second modules.

Embodiments of the present disclosure provide a free space optical communications system 2. Referring initially to FIG. 1, the system 2 comprises a first module 10 and a second module 20. The first and second modules are configured to be positioned remotely relative to each other (i.e., one or both of them can be moved relative to the other). The first module 10 is configured to transmit modulated light to the second module 20 to perform communication. The modulation of the light encodes the light with information. The modulated light thus carries information from the first module 10 to the second module 20. The light will typically comprise a wavelength in the visible range or the infrared range but other wavelengths may be used. In some embodiments the light consists of wavelengths exclusively in the visible and/or infrared ranges. Using light in the infrared range may be particularly desirable to facilitate efficient modulation of the light. Additionally, it may be desirable to transmit data in situations where visible light is undesirable, such as at night.

The first module 10 comprises a first-module transmitter 11 and a first-module steerer 12. The first module 10 may additionally comprise a first-module controller 60. The first-module controller 60 provides a first control signal. The first-module transmitter 11 is configured to transmit light out of the first module 10 via the first-module steerer 12. The first-module transmitter 11 may also apply a modulation to the light to encode the light with information to be sent to the second module 20. The modulation may be determined by the first-module controller 60.

The first-module steerer 12 redirects light received from the first-module transmitter 11. Thus, an average direction of propagation of light may be changed by the first-module steerer 12. The first-module steerer 12 is capable of controlling the redirection via the first control signal. The first-module steerer 12 may, for example, be configured to be able to select between a plurality of available (e.g. predetermined) directions of redirection. The first-module steerer 12 redirects light selectively along one or more of the available directions based on the first control signal. At any one time, the first-module steerer 12 may direct light exclusively along one and only one of the available directions or the first-module steerer 12 may direct light along multiple ones of the available directions with relative weightings defined by the first control signal. For example, the first control signal could cause a selected proportion of the transmitted power to be sent along one of the available directions and a different selected proportion of the transmitted power to be sent simultaneously along a different one of the available directions. In the schematic example of FIG. 1, the first-module steerer 12 can select between redirecting the light along a first path 5 towards the second module 20 in the upper position (solid lines) or along a second path 5′ towards the second module 20 in the lower position (broken lines). The first-module steerer 12 is thus capable of adapting to changes in the position of the second module 20 relative to the first module 10.

The second module 20 comprises a second-module detector 23 and a second-module steerer 22. The second-module detector 23 detects light from the first module 10. The second-module detector 23 may comprise a photosensitive element such as photodiode and/or a focussing configuration such as a lens for focusing light onto the photosensitive element.

The second-module steerer 22 is configured to redirect light received from the first module 10 towards the second-module detector 23. This may be done based on a second control signal. The redirection may be such that light is incident on the second-module detector 23 in a direction that is more perpendicular relative to an input surface of the second-module detector 23 (e.g., a lens) than if the redirection had not been performed. This effect allows the field of view of the second-module detector 23 to be decreased without losing any (or an excessive proportion of) the incoming light. Reducing the field of view allows the input surface (e.g., lens) to be made larger while satisfying the requirement of conservation of étendue, thus allowing more light to be captured.

In the embodiments shown, the second module 20 comprises a second-module controller 61 that provides the second control signal for controlling the second-module steerer 22. The second-module steerer 22 may, for example, redirect light received from the first module 10 selectively along one or more of a plurality of available (e.g., predetermined) directions based on the second control signal. The second-module controller 61 may provide the second control signal such that the light received from the first module 10 is caused to be redirected along the one of the available directions that most closely corresponds to (e.g., is aligned with) a location of the second-module detector 23 (e.g., to ensure that light is incident as directly/perpendicularly as possible on the second-module detector 23).

The first and second control signals allow the first-and second-module beam steerers to redirect light so that the light propagates efficiently from the first module 10 to the second module 20 and is captured efficiently at the second module 20. To perform this functionality the first and second control signals will normally contain information about the relative positions of the first and second modules. The first control signal enables the first module 10 based on this information to transmit in the correct direction when communicating with the second module 20. The second control signal enables the second module 20 based on this information to optimise its reception capabilities to receive light coming from the location of the first module 10.

In some embodiments, either or each of the first module 10 and the second module 20 comprises a light spreader. An example implementation is shown schematically in FIG. 2. In this example, the first module 10 comprises a light spreader 14. The light spreader may comprise a diffuser. Any of various known techniques for implementing a diffuser may be used. The diffuser may comprise any material that diffuses or scatters light, such as a translucent material or a diffractive diffuser. In some embodiments, the light spreader 14 comprises a light shaping diffuser. The light spreader may be configured to spread light from a radiation source (in the first module 10, the second module 20, or both) such that any image of the radiation source formed outside of the first module 10 and the second module 20 is larger than the image would be without the light spreader. This improves safety and/or allows higher powers to be safely transmitted between the first and second modules 10, 20. As depicted schematically in FIG. 2, the light spreader 14 may increase a range of angles of propagation of light between the first module 10 and the second module 20. This provides a range of locations in which the second module 20 can be positioned and still receive modulated light from the first module 10 without the first module 10 changing a redirection of the light by the first-module steerer 12. In the example of FIG. 2, it can be seen that in both of the two cases depicted (when the first-module steerer 12 is set to redirect light towards the upper path 5 and when the first-module steerer 12 is set to redirect light towards the lower path 5′), the second module 20 can be moved up and down within a range indicated by arrows 30 and still receive light from the first module 10. In the example shown, the two ranges indicated by arrows 30 are separated from each other in the vertical direction (i.e., there is gap between the lower limit of the range corresponding to path 5 and the upper limit of the range corresponding to path 5′) but this is not essential. In other arrangements the ranges are contiguous or overlapping such at that the first module 10 is able to communicate with second module 20 for a continuous range of positions along the vertical axis that is longer than the range of positions provided purely by the spreading from the light spreader 14. It is noted also that a light spreader 14 in the form of a diffuser (or as any other distinct entity) is not essential and sufficient light spreading may occur for some applications via natural divergence of the beam.

In the example of FIGS. 1 and 2, the redirection of light is performed within a plane parallel with the page. Redirection in a plane non-parallel with the page may additionally be implemented to allow the first-module steerer 12 to selectively send light to (and thereby address) a two-dimensional array of target areas 40. An example of such an array is schematically depicted in FIG. 3. Through a combination of controlling redirection of light by the first-module steerer 12, and increasing a range of angles of propagation of light for each redirection setting using a light spreader, the system 2 is able to direct light to any selected one of the target areas 40. The target areas 40 may be separated from each other, contiguous (as shown), or overlapping in edge regions.

FIG. 4 is a schematic perspective view showing how the first-module steerer 12 can be configured to selectively direct a beam along paths suitable for addressing a two-dimensional array of target areas 40 of the type depicted in FIG. 3. The first-module steerer 12 is an example of a class of embodiment in which the first-module steerer 12 comprises a plurality of steering units arranged in series. In the example shown, two steering units 31 and 32 are provided. The plurality of steering units are arranged to guide propagation of light through the steering units 31, 32 in series. In the example shown light propagates from left to right passing first through the left steering unit 31 and then through the right steering unit 32. Each of the steering units 31, 32 can selectively redirect light along any of a plurality of predetermined directions relative the steering unit 31, 32. In the example shown, each of the steering units 31, 32 provides a choice of exactly two predetermined directions along which light can be redirected for each beam incident on the steering units 31, 32 (the two predetermined directions may be different for beams incident on a given steering unit from different directions). As exemplified in FIG. 4, the plurality of predetermined directions for one of the steering units 31 lie in a first plane (e.g., a plane containing the two beam paths 51 and 52 in FIG. 4). The plurality of predetermined directions for a different one of the steering units 32 lie in a second plane (e.g., a plane containing the two directions of beam paths 53 and 54 in FIG. 4 or a plane containing the two directions of beam paths 55 and 56 in FIG. 4). The first plane is non-parallel with the second plane. Arranging for the planes to be non-parallel allows the first-module steerer 12 to address a two-dimensional array of target areas 40 such as that shown in FIG. 3. A 2×2 array of target areas 40 is shown but larger arrays may be addressed. The ability to selectively send light to individual target areas 40 and/or groups of target areas 40 rather than the whole array allows power to be focussed more on where it is needed and allows higher data transmission rates compared with the alternative of illuminating the whole of the area corresponding to the array at the same time.

As exemplified in FIG. 4, in one class of embodiment, either or both of the first-module steerer 12 and the second-module steerer 22 is implemented using a polarisation adjuster 33, 35 and a polarisation dependent redirector 34, 36.

The polarisation adjuster 33, 35 changes a polarisation of light interacting with the polarisation adjuster 33, 35. The polarisation adjuster 33, 35 may apply polarisation to unpolarized light or change a state of polarisation of polarized light. The first control signal provided by the first-module controller 60 may control the polarisation adjuster 33, 35. In some embodiments, the polarisation adjuster 33 comprises a liquid crystal cell, such as a nematic liquid crystal cell. The liquid crystal cell may be operable to switch between a plurality of different states in response to a control signal defining potentials V1, V2 (e.g., the first control signal from the first-module controller 60). For example, the birefringence of nematic liquid crystals housed in an anti-parallel rubbed glass cell changes continuously with the magnitude of the applied voltage, which gives rise to a voltage-controlled switchable waveplate that can alter the polarisation state of the incident light under proper voltages. The plurality of different states may comprise at least: a half-wave plate state in which the cell has the properties of a half-wave plate; and a full-wave plate state in which the cell has the properties of a full-wave plate.

The polarisation dependent redirector 34 may comprise a polarisation dependent diffraction grating. Diffraction gratings redirect and/or split light into one or more diffraction orders. A polarisation dependent diffraction grating is a diffraction grating where the redirection and/or splitting depends on the polarisation of the incident light. By controlling the polarisation it is possible to send light entirely into one or more selected diffraction orders and not into other diffraction orders and/or to vary a relative weighting of light intensities directed into plural available diffraction orders. A polarisation dependent diffraction grating thus allows light to be controllably sent in different directions and/or distributed between different directions with a high degree of flexibility. The plurality of selectable directions may be referred to as “available” directions.

Polarisation dependent diffraction gratings, also known as polarisation gratings (PGs) or Pancharatnam-Berry gratings, are thus space-variant polarisation devices and may be implemented by providing a periodic anisotropy across the plane of the grating that can change the phases of transmitted electric field components in one specific dimension. This leads to diffraction that is dependent on the polarisation state of the wavefront. PGs may, for example, divide a propagating plane wave into sub-waves and steer it to the +1 state and/or the −1 state based on different polarisation states of the incident light. For instance, a PG could steer a left circularly polarised light to the +1 state and a right circularly polarised light to the −1 state, while a linear polarised light would be steered equally to both +1 and −1 states.

The diffraction theory of PGs may be illustrated by introducing the Jones matrices for PGs. A PG can be regarded as a general retarder with an arbitrary fast axis angle θ_{P}. For an ideal PG working at the center wavelength (retardance is π), the Jones matrix can be indicated by:

$${J}_{P} = [ \begin{matrix}{cos}^{2} {θ}_{P} - {sin}^{2} {θ}_{P} & 2 cos {θ}_{P} sin {θ}_{P} \\ 2 cos θ sin {θ}_{P} & {sin}^{2} θ - {cos}^{2} θ\end{matrix} ] \qquad ( 1 )$$

whereθ_{P} is the spatial frequency representing the one-dimensional periodic rotation of the local fast axis. If the periodicity of the PG along the x-axis is Λ and the light is propagating in the z-axis, then the spatial frequency term can be expressed as:

$${θ}_{P} = \frac{2 π x}{Λ} . \qquad ( 2 )$$

Besides the primary beam upon diffraction, spots located at other states can also be observed in experiments. These additional spots, which possess significantly lower intensities compared with the original beam, can be divided into three categories: zero-order, sub-order, and opposite-order spots. A zero-order spot appears at the zero state with no steering and the occurrence of it is caused by inherent diffraction leakage (of the PGs) and wavelength mismatch (between the input beam wavelength and the designed centre wavelength of the PGs). The sub-order spots are located surrounding the primary beam (e.g., at the +1.5 and the +0.5 states while the primary beam is steered to the +1 state) and are caused by the slightly asymmetrical periodic structure of the PGs. The opposite-order spots appear at the opposite state compared to the primary beam. Theoretically, an ideal PG can steer a circularly polarised light entirely to a specific direction with no opposite-order spot in the opposite direction, whereas light sources with other polarisation states (linear, elliptical or non-polarised) would leave opposite-order spots upon propagating through PGs.

In the example shown in FIG. 4, the first-module steerer 12 comprises two steering units 31 and 32. The first steering unit 31 comprises a polarisation adjuster 33 in the form of a nematic liquid crystal cell switchable between a half-wave plate state and a full-wave plate state. The first steering unit 31 further comprises a polarisation dependent redirector 34 in the form of a polarisation dependent diffraction grating (polarisation grating). The second steering unit 32 comprises a polarisation adjuster 35 in the form of a nematic liquid crystal cell switchable between a half-wave plate state and a full-wave plate state. The second steering unit 32 further comprises a polarisation dependent redirector 36 in the form of a polarisation dependent diffraction grating.

In the example shown, the first-module controller 60 can direct light individually to any of the four positions A-D on a screen 50 by controlling the potentials V1, V2 applied to the two polarisation adjusters 33 and 34 in a suitable manner. For example, position A can be selected by: 1) setting V1 such that the polarisation adjuster 33 acts as a half-wave plate and directs light along beam path 51 from the polarisation adjuster 33; and 2) setting V2 such that polarisation adjuster 35 acts as a full-wave plate and directs light along beam path 54 from the polarisation adjuster 35. Position B can be selected by: 1) setting V1 such that the polarisation adjuster 33 acts as a half-wave plate and directs light along beam path 51 from the polarisation adjuster 33; and 2) setting V2 such that polarisation adjuster 35 acts as a half-wave plate and directs light along beam path 53 from the polarisation adjuster 35. Position C can be selected by: 1) setting V1 such that the polarisation adjuster 33 acts as a full-wave plate and directs light along beam path 52 from the polarisation adjuster 33; and 2) setting V2 such that polarisation adjuster 35 acts as a full-wave plate and directs light along beam path 56 from the polarisation adjuster 35. Position D can be selected by: 1) setting V1 such that the polarisation adjuster 33 acts as a full-wave plate and directs light along beam path 52 from the polarisation adjuster 33; and 2) setting V2 such that polarisation adjuster 35 acts as a half-wave plate and directs light along beam path 55 from the polarisation adjuster 35.

Thus, where the first-module steerer 12 comprises a plurality of steering units 31, 32 each having a polarisation adjuster and a polarisation dependent redirector, the polarisation dependent redirector of one of the steering units 32 may be rotated by a rotation angle (which may be 90 degrees or an oblique angle) relative to the polarisation dependent redirector of another one of the steering units 31. Where the polarisation dependent redirectors comprise gratings, the rotation may cause lines in different gratings to be non-parallel to each other when looking along a beam path. In the example of FIG. 4, the polarisation dependent redirector 36 of steering unit 32 is rotated by 90 degrees relative to the polarisation dependent redirector 34 of steering unit 31. The axis of rotation is perpendicular to planes of the two polarisation dependent redirectors 34 and 36 and/or parallel to a principal optical axis between the two steering units 31 and 32. Providing a rotational offset between the two polarisation dependent redirectors 34 in this way allows the first-module steerer 12 to address a two-dimensional array of target areas 40 such as that shown in FIG. 3.

The system 2 may be configured to operate in a two-way (also referred to as bidirectional) communication mode, as depicted schematically in FIG. 5. Thus, the first module 10 may further comprise first-module detector 73. The first-module detector 73 is configured to detect light from the second module 20. The first-module detector 73 may take any of the forms described above for the second-module detector 23. The first-module steerer 12 is configured to redirect light received from the second module 20 towards the first-module detector 73. The angle of the direction should normally be the same in both directions for a given relative positioning of the first and second modules 10, 20. Thus, the first-module steerer 12 may redirect light received from the second module 20 towards the first-module detector 73 at the same angle as the first-module steerer 12 redirects light received from the first-module transmitter 11 towards the second module 20 (i.e., along equal and opposite directions as compared to the redirection by the first-module steerer 12 of light received from the first-module transmitter 11 towards the second module 20).

The arrangement of FIG. 5 is an example of a class of embodiment in which the first-module steerer 12 comprises a first polarisation adjuster 33A and a first polarisation dependent redirector 34 configured to redirect light received from the first-module transmitter 11 towards the second module 20 based on a first control signal (e.g., from a first-module controller 60). The first polarisation adjuster 33A changes a polarisation of light received from the first-module transmitter 11 based on the first control signal. The first polarisation dependent redirector 34 selectively redirects light received from the first polarisation adjuster 33A along one or more of a plurality of available directions as a function of the polarisation of the light. The first control signal can thus select which of the available directions the light travels along.

The arrangement of FIG. 5 is also an example of a class of embodiment in which the second-module steerer 22 comprises a second polarisation adjuster 37A and a second polarisation adjuster 38 configured to redirect light received from the first module 10 towards the second-module detector 23 based on a second control signal (e.g., from a second-module controller 61). The second polarisation adjuster 37A changes a polarisation of light received from the first module 10 based on the second control signal. The second polarisation dependent redirector 38 selectively redirects light received from the second polarisation adjuster 37A along one or more of a plurality of available directions as a function of the polarisation of the light. The second control signal can thus select from which of the available directions light can be most optimally detected by the second-module detector 23.

The first and second polarisation adjusters 33A and 37A may take any of the forms described above with reference to FIG. 4, including comprising nematic liquid crystal cells. The first and second polarisation dependent redirectors 34 and 38 may take any of the forms described above with reference to FIG. 4, including comprising polarisation dependent diffraction gratings.

In the embodiment shown, the first-module steerer 12 performs the redirection of light received from the second module 20 towards the first-module detector 73 by passing the light through a further polarisation adjuster 33B (optionally separate from the first polarisation adjuster 33A and/or on an opposite side of the first polarisation dependent redirector 34) and the first polarisation dependent redirector 34. Thus, light is passed in both directions through the same first polarisation dependent redirector 34. The same polarisation dependent redirector (e.g., polarisation dependent diffraction grating) 34 is thus used in both processes (i.e., in the redirection of light received from the first-module transmitter 11 and in the redirection of light received from the second module 20). The first polarisation adjuster 33A and the further polarisation adjuster 33B may be controlled (e.g., by the first control signal) to provide redirection along equal and opposite directions since the directions are dictated in both senses by the same relative positions of the first and second modules 10 and 20.

As further exemplified in FIG. 5, the second module 20 may be configured to transmit modulated light from the second module 20 to the first module 10. The second module 20 may further comprise a second-module transmitter 71 configured to generate light for transmission. In this embodiment, the second-module steerer 22 is configured to perform the redirection of light from the second-module transmitter 71 by passing the light through a further polarisation adjuster 37B and the second polarisation dependent redirector 38.

The first-module steerer 12 is large enough to allow the first-module detector 73 and the first-module transmitter 11 to be positioned adjacent to each other. In the example shown, this is achieved by arranging the first polarisation dependent redirector 34 (which as described above may be a polarisation dependent diffraction grating) to be large enough (e.g., wide enough) to span across beam paths to/from both the first-module detector 73 and the first-module transmitter 11. Similarly, the second-module steerer 22 may be arranged to be large enough to allow the second-module detector 23 and the second-module transmitter 71 to be positioned adjacent to each other, which may include making the second polarisation dependent redirector 38 large enough (e.g., wide enough) to span across beam paths to/from both the second-module detector 23 and the second-module transmitter 71.

Either or both of the first and second modules 10, 20 may comprise a light spreader 14 (e.g., a diffuser) to spread light emitted from the respective module (as indicated schematically by the diverging thick arrows between the first and second modules 10, 20 in both directions in FIG. 5).

In some embodiments, the system 2 further comprises one or more module locators 80 configured to determine relative positions of first and second modules 10, 20 and send the information to either or both of the first and second modules 10, 20 (e.g., to first-and second-module controllers 60, 61 in the first and second modules 10, 20). Determining the relative positions of the first and second modules 10, 20 may be referred to as localization. The first-module controller 60 may be configured to control the redirection of the light received from the first-module transmitter 21 in response to the determined position of the second module 20 relative to the first module 10. Any of various known techniques may be used to perform the localization. For example, the module locator 80 may perform polling to request localization information to be sent to the module locator 80 from one or more of the modules (e.g., from the second module 20 at least). Alternatively or additionally, an auxiliary data channel may be used, such as a Wi-Fi localization scheme, or an optical detection system that identifies locations of visible beacon signals emitted by the modules.

FIG. 6 is a flow chart schematically depicting a framework for a preferred localization procedure performed by the first and second modules 10 and 20.

In step S1, the first module 10 sends a first localization signal as transmitted light to the second module 20. In some embodiments, the first module 10 comprises a beam divergence adjuster that allows the first module 10 to be selectively operable in a wide angle transmission mode in which the first module 10 transmits light into a wide solid angle and a narrow angle transmission mode in which the first module 10 transmits light into a narrower solid angle. In some embodiments, the light spreader 14 described above with reference to FIG. 5, for example, could be used to implement the beam divergence adjuster. The light spreader 14 could be programmable, for example, to allow different amounts of light spreading to be achieved (with more light spreading for the wide angle transmission mode than for the narrow angle transmission mode). Where such a wide angle transmission mode is available, the first localization signal may be sent in the wide angle transmission mode. This may be desirable in step S1 because at this stage the first module 10 may have no or only relatively approximate information about the location of the second module 20. Sending the first localization signal in the wide angle transmission mode provides a high chance of the second module 20 receiving a portion of the first localization signal without the first localization signal needing to be steered along many different directions by the first module 10. Spreading a beam power over a large solid angle is acceptable during such a localization procedure as it is not necessary at this stage to transmit a large amount of data to the second module 20.

In step S2, the second module 20 uses the second-module steerer 22 to sequentially apply a plurality of different redirections to light received from the first module 10 and to select as an optimal redirection for the second-module steerer 22 the redirection that provides a strongest signal at the second-module detector 23.

In step S3, the second module 20 sends a second localization signal as transmitted light to the first module 10. The second localization signal may be sent using the optimal redirection for the second-module steerer 22 selected in step S2. The second localization signal may alternatively or additionally be sent in a wide angle transmission mode.

In step S4, the first module 10 uses the first-module steerer 12 to sequentially apply a plurality of different redirections to light received from the second module 20 and to select as an optimal redirection for the first-module steerer 12 the redirection that provides a strongest signal at the first-module detector 73.

In step S5, bidirectional communication between the first and second modules is performed (e.g., initiated or restarted after an interruption) after completion of the localization procedure of steps S1-S4. The bidirectional communication is performed while: controlling the first-module steerer 12 to redirect light based on the selected optimal redirection for the first-module steerer 12; and controlling the second-module steerer 22 to redirect light based on the selected optimal redirection for the second-module steerer 22.

1. A free space optical communications system, comprising:
a first module and a second module, the first module being configured to transmit modulated light to the second module, wherein:
the first module comprises a first-module transmitter and a first-module steerer;
the first-module transmitter is configured to transmit light out of the first module via the first-module steerer;
the first-module steerer is configured to redirect light received from the first-module transmitter towards the second module based on a first control signal, the first-module steerer comprising: a first polarisation adjuster configured to change a polarisation of the received light based on the first control signal; and a first polarisation dependent redirector configured to selectively redirect light received from the first polarisation adjuster along one or more of a plurality of available directions as a function of the polarisation of the light;
the second module comprises a second-module steerer and a second-module detector;
the second-module steerer is configured to redirect light received from the first module towards the second-module detector based on a second control signal, the second-module steerer comprising: a second polarisation adjuster configured to change a polarisation of the received light based on the second control signal; and a second polarisation dependent redirector configured to selectively redirect light received from the second polarisation adjuster along one or more of a plurality of available directions as a function of the polarisation of the light; and
the second-module detector is configured to detect light from the first module.

2. The system of claim 1, wherein the first and second control signals represent relative positions of the first and second modules.

3. The system of claim 1, wherein either or each of the first module and the second module comprises a light spreader, optionally a diffuser, configured to spread light from a radiation source such that any image of the radiation source formed outside of the first module and the second module is larger than the image would be without the light spreader.

4. The system of claim 1, wherein the first module further comprises a first-module detector configured to detect light from the second module to allow bidirectional communication between the first and second modules.

5. The system of claim 4, wherein the first-module steerer is configured to redirect light received from the second module towards the first-module detector along equal and opposite directions as compared to the redirection by the first-module steerer of light received from the first-module transmitter towards the second module.

6. The system of claim 5, wherein the first-module steerer is large enough to allow the first-module detector and the first-module transmitter to be positioned adjacent to each other.

7. The system of claim 4, wherein the first-module steerer is configured to redirect light received from the second module towards the first-module detector by passing the light through a further polarisation adjuster and the first polarisation dependent redirector.

8. The system of claim 4, wherein the first module and the second module are configured to perform a localization procedure comprising:
the first module sending a first localization signal as transmitted light to the second module; and
the second module using the second-module steerer to sequentially apply a plurality of different redirections to light received from the first module and to select as an optimal redirection for the second-module steerer the redirection that provides a strongest signal at the second-module detector.

9. The system of claim 8, wherein:
the first module comprises a beam divergence adjuster configured to allow the first module to be selectively operable in a wide angle transmission mode in which the first module transmits light into a wide solid angle and a narrow angle transmission mode in which the first module transmits light into a narrower solid angle; and
the first module is configured to send the first localization signal in the wide angle transmission mode.

10. The system of claim 8, wherein the localization procedure further comprises:
the second module sending a second localization signal as transmitted light to the first module, optionally using the selected optimal redirection for the second-module steerer; and
the first module using the first-module steerer to sequentially apply a plurality of different redirections to light received from the second module and to select as an optimal redirection for the first-module steerer the redirection that provides a strongest signal at the first-module detector

11. The system of claim 10, wherein the first module and the second module are configured to perform bidirectional communication after completion of the localization procedure while:
controlling the first-module steerer to redirect light based on the selected optimal redirection for the first-module steerer; and/or
controlling the second-module steerer to redirect light based on the selected optimal redirection for the second-module steerer.

12. The system of claim 1, wherein either or each of the first polarisation adjuster and the second polarisation adjuster comprises a liquid crystal cell, optionally a nematic liquid crystal cell.

13. The system of claim 12, wherein the liquid crystal cell is operable to switch between a plurality of different states in response respectively to the first control signal or the second control signal, the plurality of different states comprising at least: a half-wave plate state in which the cell has the properties of a half-wave plate; and a full-wave plate state in which the cell has the properties of a full-wave plate.

14. The system of claim 1, wherein either or each of the first polarisation dependent redirector and the second polarisation dependent redirector comprises a polarisation dependent diffraction grating.

15. The system of claim 1, wherein either or each of the first-module steerer and the second-module steerer comprises:
a plurality of steering units arranged to guide propagation of light through the steering units in series, wherein each of the steering units is capable of redirecting light selectively along any of a plurality of predetermined directions relative to the steering unit.

16. The system of claim 15, wherein the plurality of predetermined directions for one of the steering units lie in a first plane and the plurality of predetermined directions for a different one of the steering units lie in a second plane, and the first plane is non-parallel with the second plane.

17. The system of claim 15, wherein:
each of the steering units comprises: a polarisation adjuster configured to change a polarisation of light interacting with the polarisation adjuster; and a polarisation dependent redirector, preferably a polarisation dependent diffraction grating, configured to redirect light received from the polarisation adjuster as a function of a polarisation of the light; and
the polarisation dependent redirector of one of the steering units is rotated by a rotation angle relative to the polarisation dependent redirector of another one of the steering units.

18. The system of claim 17, wherein the rotation angle is 90 degrees.

19. A method of performing free space optical communication between a first module and a second module, the method comprising:
generating light for transmission from the first module to the second module;
controlling a first polarisation adjuster to change a polarisation of the generated light and using a first polarisation dependent redirector to selectively redirect light received from the first polarisation adjuster along one or more of a plurality of available directions as a function of the polarisation of the light; and
redirecting light received from the first module at the second module towards a second-module detector.

20. The method of claim 19, wherein the redirection of light received from the first module is performed by controlling a second polarisation adjuster to change a polarisation of the received light in such a way that a second polarisation dependent redirector receiving the light redirects the light into a selected one of a plurality of available directions that is most closely aligned with the second-module detector.

21. The method of claim 19, further comprising performing a localization procedure, the localization procedure comprising:
sending a first localization signal as transmitted light, optionally in a wide angle transmission mode, from the first module to the second module; and
controlling the second polarisation adjuster to sequentially apply a plurality of different redirections to light received from the first module and to select as an optimal redirection for the second polarisation adjuster the redirection that provides a strongest signal at the second-module detector.

22. The method of claim 21, wherein the localization procedure further comprises:
sending a second localization signal as transmitted light from the second module to the first module; and
controlling the first polarisation adjuster to sequentially apply a plurality of different redirections to light received from the second module and to select as an optimal redirection for the first polarisation adjuster the redirection that provides a strongest signal at a first-module detector.

23. The method of claim 21, further comprising performing bidirectional communication after completion of the localization procedure while:
controlling the first polarisation adjuster to redirect light based on the selected optimal redirection for the first polarisation adjuster; and/or
controlling the second polarisation adjuster to redirect light based on the selected optimal redirection for the second polarisation adjuster.
